(19) United States
(12) Patent Application Publication
(10) Pub. No.: US 2010/0241342 A1
(43) Pub. Date: Sep. 23, 2010

(54) DYNAMIC TRAFFIC ASSESSMENT AND REPORTING

(75) Inventors: Mark Scalf, Warren, MI (US); Joseph J. Berry, Northville, MI (US)

Correspondence Address: BROOKS KUSHMAN P.C./FGTL, 1000 TOWN CENTER, 22ND FLOOR, SOUTHFIELD, MI, 48075-1238, US

(73) Assignee: FORD GLOBAL TECHNOLOGIES, LLC, Dearborn, MI (US)

(21) Appl. No.: 12/406,595

(22) Filed: Mar. 18, 2009

(51) Int. Cl. G08G 1/0969

(52) U.S. Cl. 701/117; 701/209; 701/204; 701/211

(57) ABSTRACT

A vehicle communication system is capable of calculating a plurality of routes between two locations. The system can also overlay traffic data for each route to determine a “real time” travel estimate. Then, one or more optimal routes can be presented to a user along with traffic data.

### TECHNICAL FIELD

The illustrative embodiments relate generally to dynamic assessment and reporting of traffic conditions.

### BACKGROUND

A number of GPS systems, including portable GPS, cell-phone based GPS, and in-car GPS, exist nowadays, providing users with directions from a present location to a desired destination. In many modern GPS solutions, the user uses a touch screen to input a destination, and the GPS system will determine a route to the user's destination.

Various algorithms exist for determining an optimal route for a user to travel. In one illustrative instance, the GPS system will use a database of known road speeds. Based on the road speeds, the system will recommend what it believes to be the fastest route to a destination.

Other optimization algorithms are also possible. For example, the GPS system could be instructed to avoid major highways, or alternative, look for routes that mostly involve major highways (to avoid traffic lights and stop signs). The GPS system could be instructed to avoid unpaved roads, or the GPS system could be instructed to find the shortest distance, which may not necessarily be the fastest route.

Whatever criteria are used, the GPS system takes into account the relevant factors and accesses a database of stored road information. Generally, the database system acts as a large a map or atlas.

Since it has been recognized that traffic can significantly decrease the speed of travel along a given route, companies have been developed that provide databases of present traffic conditions. GPS systems can then access these databases and use the information contained therein to modify travel instructions to provide, for example, the quickest route.

According to at least one existing system, traffic information is obtained from a database in the form of an average speed of travel along a road. This could be for a mile of the road, a tenth of a mile, a kilometer, or any other suitable interval. The speeds are then used to determine a speed of travel along the portions of the road along which the user must travel. For example, the speeds over each of N miles could be averaged to determine an average speed for a stretch of N miles. That speed is then used as the speed of the road, when determining the fastest route to travel. If this results in a significantly low enough speed for a road, an alternate route with the fastest travel time may be provided. Below is an example of how this may work:

STANDARD ROUTE:

Surface road A for 5 miles (speed limit 35 mph)

Highway B for 10 miles (speed limit 60 mph)

Surface road C for 3 miles (speed limit 40 mph)

In the above example, the GPS system will determine that the fastest route of A-B-C should take approximately 23 minutes to cover the 18 miles. However, if traffic is heavy on Highway B, the average actual travel speed may only be 25 mph. Perhaps there is a road that parallels Highway B on which there is little traffic and the speed limit is 40 mph. In this instance:

STANDARD ROUTE:

Surface road A for 5 miles (speed limit 35 mph)

Highway B for 10 miles (effective speed limit 25 mph)

Surface road C for 3 miles (speed limit 40 mph)

Estimated travel time ˜37 minutes

ALTERNATE ROUTE:

Surface road A for 5.1 miles (speed limit 35 mph)

Surface road D 10 miles (speed limit 60 mph)

Surface road C for 3.1 miles (speed limit 40 mph)

Estimated travel time ˜28 minutes

In this example, the GPS system would instruct the user to take the alternate route, although that route is slightly longer.

### SUMMARY OF ILLUSTRATIVE EMBODIMENTS

According to one or more illustrative implementations, traffic information from an existing traffic database is used to help determine an optimal route of travel. In this illustrative embodiment, the traffic information is first compared against a preferred route of travel. An estimated time of travel is determined, and a traffic report for the preferred route of travel is prepared.

In this illustrative embodiment, a plurality of routes between a starting location and a destination are stored in memory. These routes are input by a user, and may represent preferred routes between the starting location and destination. According to this illustrative implementation, the processor may receive traffic data relating to each of the plurality of preferred routes and may calculate an estimated travel time for each of the plurality of the preferred routes, based at least in part on the received traffic data.

This provides an estimated time of travel for the preferred routes, based on, for example, real-time traffic data (or stored traffic data, etc, that is likely close to real time).

According to this illustrative embodiment, the processor may select, from the preferred routes and based at least in part on the estimated travel time, an optimal route of travel to be output to at least one output device.

The user may then also be presented with the traffic information for the optimal route, along with the traffic information for one or more alternate routes. This presentation of information can aid the user in making an educated decision on which route to take.

For example, using the STANDARD and ALTERNATE route information provided in the background, while the estimated travel time on the ALTERNATE route may be faster, the user may know that there are twenty stop lights on that route, and that the synchronization of the stop lights is not done well. Accordingly, even though an unfettered trip along that route may take 28 minutes, an actual trip is likely to take closer to 40-45 minutes. In this instance, since the STANDARD highway based route is only 37 estimated minutes, the user may elect to travel on this route instead.

In another illustrative embodiment, a vehicle communication system includes a computer processor in communication with persistent and non-persistent memory and one or more output devices controllable by the processor. In this illustrative embodiment, the processor may receive traffic data relating to a route to be traveled and calculate an estimated time of travel along the route based at least in part on the received traffic data. This provides a baseline estimate for a route to be traveled.

Additionally, in this embodiment, the processor may evaluate a subset of a route to be traveled to determine one or more portions having concentrations of traffic above a predetermined threshold. For example, only a portion of a highway may have traffic on it, and in this embodiment, the processor can zero-in on this portion.

Further, the processor may determine, for each portion having a concentration of traffic above the predetermined threshold, at least one alternative route, if an alternative route exists. In this illustrative embodiment, the processor may be “routing-around” traffic congestion (e.g., exit at exit 68 and re-enter at exit 70).

For each alternative route, or, in this example, route-around, the processor may further receive traffic data relating to each determined alternative route and calculate an estimated time of travel along each alternative route. This can aid in a determination as to whether or not a user should take a route-around or the main route.

The processor may also output one or more alternative routes, including traffic information, to at least one of the output devices. In one example, this output is provided in response to a user request to provide an alternate route.

In yet another embodiment, the user may have a customizable web-page into which he can input one or more preferred routes of travel. If there are, for example, five or six routes which can reach a destination, and all have similar travel times (excepting traffic), the user may have one or two that he prefers. Accordingly, he may access a website and input this information. When a vehicle communication system, through which the traffic information and reports may be provided, synchronizes with a network that has access to the user's stored information, the system knows which routes the user prefers. The system can then calculate estimated travel times and traffic reports for the preferred routes, along with alternative options and traffic reports if the preferred routes are backed up.

### BRIEF DESCRIPTION OF DRAWINGS

Other objects, aspects and characteristics of the illustrative embodiments will become apparent from the following detailed description of exemplary embodiments, when read in view of the accompanying drawings, in which:

FIG. 1 shows an exemplary, illustrative vehicle communication system;

FIG. 2 shows an exemplary illustrative process flow for one exemplary embodiment for traffic lookup, processing and reporting;

FIG. 3 shows an exemplary illustrative process flow for one exemplary embodiment for avoiding existing traffic;

FIGS. 4A-4C show exemplary illustrative process flows for exemplary sub-portions of the process of FIG. 3;

FIG. 5 shows one exemplary illustrative display of route summary and traffic information;

FIG. 6 shows the exemplary illustrative display of FIG. 5 with additional information displayed thereon; and

FIG. 7 shows an exemplary routine for determining and displaying preferred routes.

### DETAILED DESCRIPTION OF ILLUSTRATIVE EMBODIMENTS

The present invention is described herein in the context of particular exemplary illustrative embodiments. However, it will be recognized by those of ordinary skill that modification, extensions and changes to the disclosed exemplary illustrative embodiments may be made without departing from the true scope and spirit of the instant invention. In short, the following descriptions are provided by way of example only, and the present invention is not limited to the particular illustrative embodiments disclosed herein.

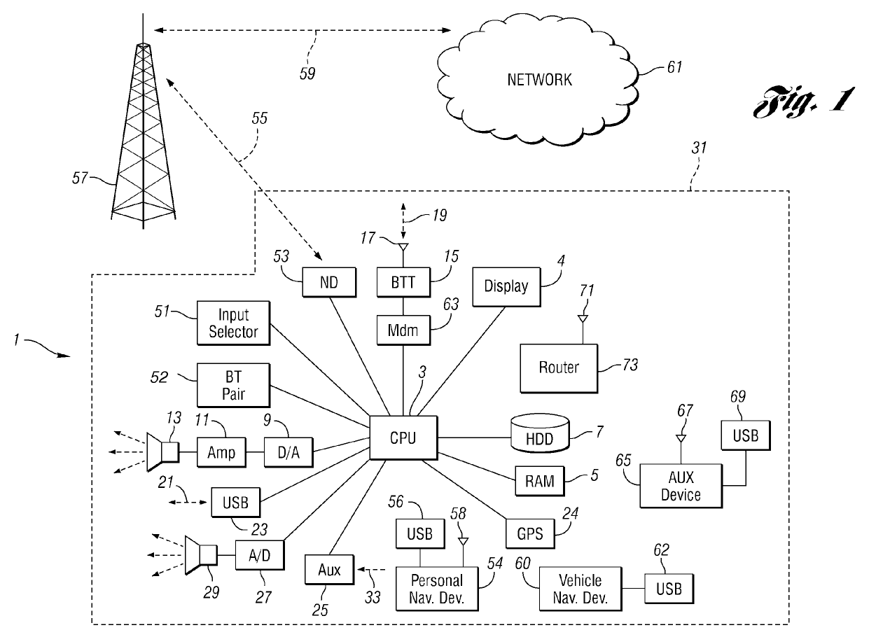

FIG. 1 illustrates system architecture of an illustrative onboard communication system usable for delivery of directions to an automobile. A vehicle enabled with a vehicle-based computing system may contain a visual front end interface 4 located in the vehicle. The user may also be able to interact with the interface if it is provided, for example, with a touch sensitive screen. In another illustrative embodiment, the interaction occurs through, button presses, audible speech and speech synthesis.

In the illustrative embodiment 1 shown in FIG. 1, a processor 3 controls at least some portion of the operation of the vehicle-based computing system. Provided within the vehicle, the processor allows onboard processing of commands and routines. Further, the processor is connected to both non-persistent 5 and persistent storage 7. In this illustrative embodiment, the non-persistent storage is random access memory (RAM) and the persistent storage is a hard disk drive (HDD) or flash memory.

The processor is also provided with a number of different inputs allowing the user to interface with the processor. In this illustrative embodiment, a microphone 29, an auxiliary input 25 (for input 33), a USB input 23, a GPS input 24 and a BLUETOOTH input 15 are all provided. An input selector 51 is also provided, to allow a user to swap between various inputs. Input to both the microphone and the auxiliary connector is converted from analog to digital by a converter 27 before being passed to the processor.

Outputs to the system can include, but are not limited to, a visual display 4 and a speaker 13 or stereo system output. The speaker is connected to an amplifier 11 and receives its signal from the processor 3 through a digital-to-analog converter 9. Output can also be made to a remote BlueTooth device such as PND 54 or a USB device such as vehicle navigation device 60 along the bi-directional data streams shown at 19 and 21 respectively.

In one illustrative embodiment, the system 1 uses the BlueTooth transceiver 15 to communicate 17 with a user's nomadic device 53 (e.g., cell phone, smart phone, PDA, etc.). The nomadic device can then be used to communicate 59 with a network 61 outside the vehicle 31 through, for example, communication 55 with a cellular tower 57.

Pairing a nomadic device 53 and the BlueTooth transceiver 15 can be instructed through a button 52 or similar input, telling the CPU that the onboard BlueTooth transceiver will be paired with a BlueTooth transceiver in a nomadic device.

Data may be communicated between CPU 3 and network 61 utilizing, for example, a data-plan, data over voice, or DTMF tones associated with nomadic device 53. Alternatively, it may be desirable to include an onboard modem 63 in order to transfer data between CPU 3 and network 61 over the voice band. In one illustrative embodiment, the processor is provided with an operating system including an API to communicate with modem application software. The modem application software may access an embedded module or firmware on the BlueTooth transceiver to complete wireless communication with a remote BlueTooth transceiver (such as that found in a nomadic device). In another embodiment, nomadic device 53 includes a modem for voice band or broadband data communication. In the data-over-voice embodiment, a technique known as frequency division multiplexing may be implemented when the owner of the nomadic device can talk over the device while data is being transferred. At other times, when the owner is not using the device, the data transfer can use the whole bandwidth (300 Hz to 3.4 kHz in one example).

If the user has a data-plan associated with the nomadic device, it is possible that the data-plan allows for broad-band transmission and the system could use a much wider bandwidth (speeding up data transfer). In still another embodiment, nomadic device 53 is replaced with a cellular communication device (not shown) that is affixed to vehicle 31.

In one embodiment, incoming data can be passed through the nomadic device via a data-over-voice or data-plan, through the onboard BlueTooth transceiver and into the vehicle's internal processor 3. In the case of certain temporary data, for example, the data can be stored on the HDD or other storage media 7 until such time as the data is no longer needed.

Additional sources that may interface with the vehicle include a personal navigation device 54, having, for example, a USB connection 56 and/or an antenna 58; or a vehicle navigation device 60, having a USB 62 or other connection, an onboard GPS device 24, or remote navigation system (not shown) having connectivity to network 61.

Further, the CPU could be in communication with a variety of other auxiliary devices 65. These devices can be connected through a wireless 67 or wired 69 connection. Also, or alternatively, the CPU could be connected to a vehicle based wireless router 73, using for example a WiFi 71 transceiver. This could allow the CPU to connect to remote networks in range of the local router 73.

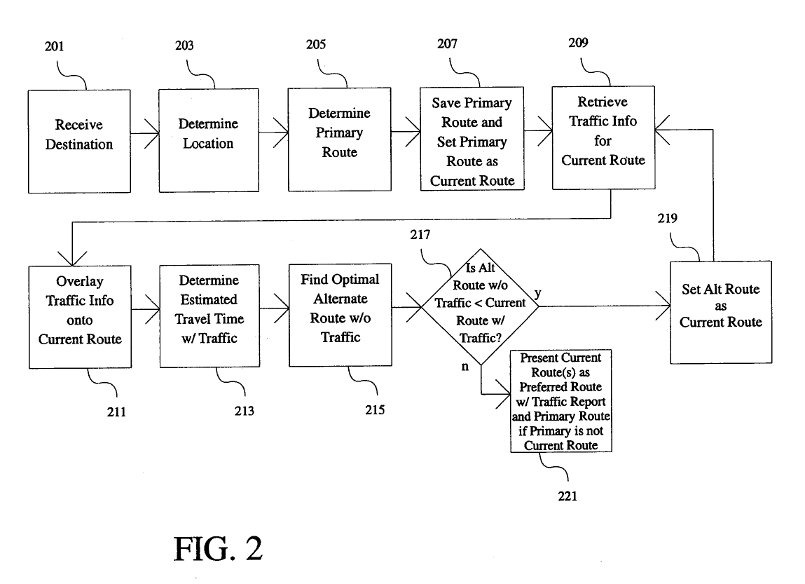

FIG. 2 shows an exemplary illustrative process flow for one exemplary embodiment for traffic lookup, processing and reporting. When the vehicle communication system is preparing to present one or more possible routes to a driver, it first receives a destination 201, input by the driver or another passenger. This can be done through the use of an LCD display, verbally, pre-set (e.g. through a website and then downloaded to the vehicle), etc.

After receiving the destination from a driver, the vehicle communication system determines the present location of the vehicle 203. This can be done using, for example GPS coordinates. Additionally, although these and other steps of this exemplary process are described as being done by the vehicle communication system, they can also be done at a remote location and the relevant results can be transmitted to the vehicle for use by the vehicle communication system.

After the destination and location are known, a primary route is determined 205. The primary route can be based on a shortest distance, a fastest time, a desire to avoid highways, etc. In a simple example, it is assumed that the primary route is determined based on a fastest route to travel in the absence of traffic. For example, in this illustrative determination, the system determining the route to travel may have information relating to the speeds of various roads between a starting location and a destination. Combining the speed information with the distances to be traveled on different roads, a fastest route to a destination may be established.

In this illustrative implementation, after the primary route is established, it is saved (or otherwise designated) and then is set as a “current route” for consideration 207. After the “current route” is designated, traffic information for the current route is retrieved 209. This information can be retrieved from a site, database, service, etc. that provides dynamic, real-time traffic information.

In this illustrative implementation, the traffic information includes the speed of traffic on a given road. This could be an average speed over a long stretch of road, an average speed over a requested stretch of road, an average speed at a given point on a road, or any other suitable representation of real-time traffic speed. For purposes of this example, it will be assumed that the traffic information includes the average speed over the requested stretch of road (e.g. 37 mph from mile 66 to mile 76).

Once the traffic speed for each relevant portion of road is known, the speed of traffic is overlayed over the distances to be traveled 211, effectively replacing the speed limits on those roads in the system's calculations. For example, if a 60 mph highway is traveled on for ten miles, but traffic is presently only moving at 30 mph over those ten miles, the 30 mph supplants the 60 mph speed limit as the speed of travel on that road for purposes of calculations.

Once the actual speeds of travel are known, a new estimated travel time for the current route is determined 213, using those speeds. Accordingly, the system now knows how long it should take along a preferred route, given current traffic, for the driver to reach the desired destination.

After the traffic-based travel time is determined, at least one alternate route is determined 215. Since traffic information for the alternate route has not yet been retrieved, in this illustrative embodiment, the route is determined at speeds without traffic (e.g., stored speed limits). That is, the route is determined as if there were no traffic on any alternate routes.

Additionally, since the alternate route may, before traffic is integrated, contain some or most portions of the preferred route, the alternate route can be determined with several additional or alternative considerations. For example, the alternate route can be one of several alternate routes pre-programmed by a driver as acceptable alternates. Or, the route can include no more than N% of the primary route. It is possible that the system determining the alternate route will have to run through a series of possible alternates before finding a preferred alternate route.

Once the optimal alternate route (e.g., the route that meets all constraints on an alternate route and has, for example, a “no-traffic” fastest time to destination other than the primary route) has been determined, the system checks to see if the alternate route travel time without traffic is faster than the actual traffic-based travel time on the primary route 217. For example, if the primary route normally takes twenty-five minutes to travel it may take forty minutes to travel with traffic. But, the next criteria-matching alternate route may take fifty minutes with no traffic. In this case, it is safe to assume that regardless of whether or not there is any traffic on the alternate route, the primary route with traffic (at the present state of traffic at least), is faster than the alternate route (assuming the speed limit is not exceeded). Since the system can dynamically and constantly update, the user can be notified at any point if this condition changes.

If the alternate route without traffic is slower than the primary route with traffic, it may be the case that only the primary route is presented to the user 221. In addition to presentation of the route (or a route summary), traffic information for the route may also be presented to the user. For example, this could be as simple as a designation that traffic is at a certain level (low, med, high, or different color designations ranging from, for example, green to red), or it could be a more detailed description of traffic. The level of traffic detail may also depend on how much traffic information is available.

If the alternate route without traffic is faster than the primary route with traffic, the alternate route is set as the current route 219, and the traffic evaluation is performed for the new current route. In this manner, a number of alternate routes can be examined, and one or more acceptable alternate routes that have faster traffic-based travel times than the preferred route can be presented, with traffic information, as alternate routes.

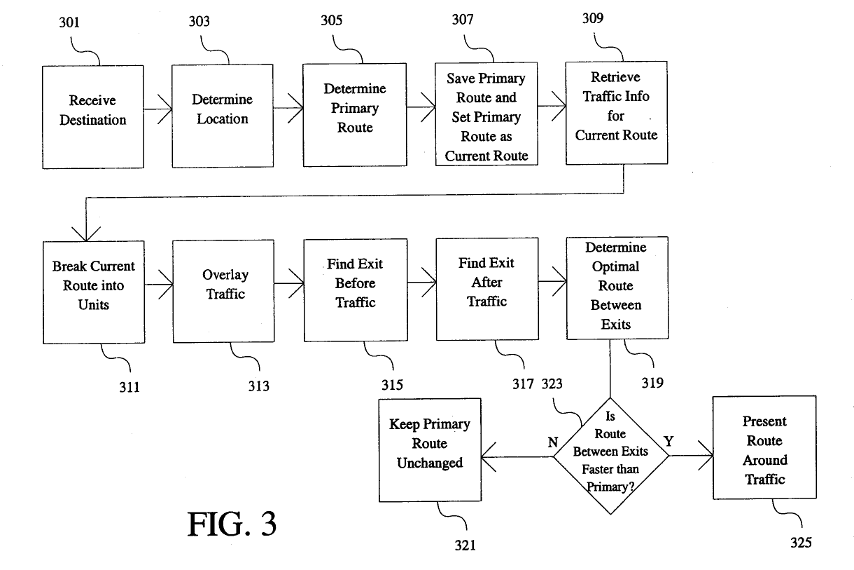

FIG. 3 shows an exemplary illustrative process flow for one exemplary embodiment for avoiding existing traffic. In an alternative illustrative implementation, the user may not want an alternate route that does not generally follow a preferred route, or suitable alternatives may not exist. For example, it may be the case that travel on a major highway is generally required to reach a destination, if that is the only main artery between a present location and the destination. Thus, it may be desirable to approach an alternate route determination as a route-around of places on the highway where traffic is heavily congested. Even if a main highway is a preferred and generally only available route, there are often surface roads that run for several miles and can allow a user to avoid the thickest portions of traffic if the user is made aware of the route-arounds.

In this case, as with the previous illustrative non-limiting implementation shown in FIG. 2, a system making route determinations will first receive a destination 301 input by a user and a present location 303, determined, for example, based on GPS coordinates. Also, as with the previous example, the primary route may be determined 305 based on desired limitations. The primary route may then be set as a “current route” 307 and the traffic information may be retrieved for the current route 309.

In this illustrative implementation, the current route is then broken into units of N length 311. For example, if ten miles are to be traveled on a given highway, it may be desirable to break the travel on the highway into units of one mile each. The unit break of one mile may also be generally useful on highway travel, where exits tend to be laid out roughly on the mile when present. Once the route is broken into units, traffic is overlaid on the route 313, and traffic over a given unit can be determined.

As one illustrative example, if ten miles were to be traveled on a highway, and traffic over miles four and five was moving at five miles per hour, because of, for example, an accident, the traffic over the ten mile stretch might appear to average forty nine miles per hour, even though traffic on miles one through three and six through ten may be moving at sixty miles per hour. Accordingly, it may be desirable to route the user around miles four and five, if possible, so as to avoid the thick of the congestion.

Once the system can determine which units have the most traffic, or, for example, any units with traffic over a certain threshold (e.g., where travel is less than N % of the speed limit), the system can then find an exit before the traffic occurs 315. Since the user may also need or want to re-enter the highway at some point, an exit after the traffic occurs 317 is also determined. Once the exits before and after the traffic are known, the system can then determine an optimal non-highway route between the exits 319 (avoiding the highway traffic). Ideally, traffic information will also be available for the non-highway route. Once the non-highway route is determined, traffic for the non-highway route can be overlaid to see if that route is, in fact, a faster route.

For example, a large portion of the highway traffic may also be attempting to route around an accident, resulting in heavy traffic on surface roads as well. Since real-time traffic information for both the highway and the route-around surface roads is available, it should be possible to know the optimal choice between the highway and the route-around up until it is time to either exit or stay on the highway.

The system can then determine which route is faster 323, and present either the primary route 321 or the route-around 325 as the optimal path of travel.

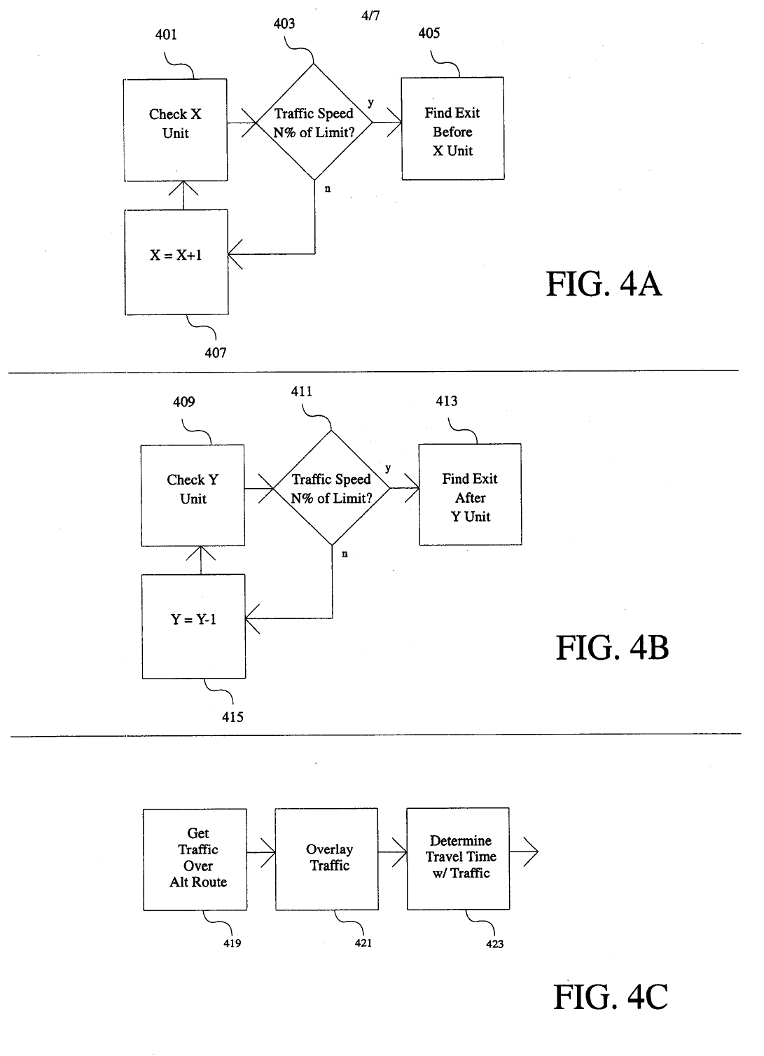

FIGS. 4A-4C show exemplary illustrative process flows for exemplary sub-portions of the process of FIG. 3. FIG. 4A shows one illustrative, exemplary, non-limiting process for finding an exit before traffic occurring on a “current route.” In this illustrative implementation, the system checks the X unit of travel on a road 401 (e.g., to start at the beginning, X=1). On that unit of travel, the system checks to see if the traffic speed is N % of the speed limit 403. This is just one example of how to determine whether a unit has traffic that is desired to be avoided.

If the speed is N % of the speed limit or less, indicating traffic above a desired level, then the system proceeds to find the first available exit before unit X of the road 405. For example, if traffic began to get heavy at the third unit, then the system would find the first exit before the third unit of travel. If traffic on unit X of the road is not past the threshold, then X is incremented 407 and the check is performed again.

FIG. 4B shows one illustrative, exemplary, non-limiting process for finding an exit after traffic has ended. In this illustrative implementation, the system checks the Y unit of travel on a road 409 (e.g., to start at the end of the road, Y=the last unit of travel, which, in the ten mile example, would be 10). As with the check in FIG. 4A, the system determines if the traffic speed is N % of the speed limit 411. If so, then an exit after the Y unit of travel is found 413. If traffic is not beyond the threshold, then Y is decremented 415 until a unit of travel having threshold traffic is reached.

It is important to note that these methods of “bracketing” traffic are illustrative only. Further, they may need to be modified or replaced with other suitable methods depending on a situation. For example, if traffic is found at the first Y value, then it may no make sense to route past that value, since doing so would place the user beyond the desired point of travel on the road. Also, it is possible that traffic is present at several spots along a highway, and counting up from the bottom and down from the top would bracket all the traffic, but ignore what could be a large, traffic-free gap in the middle. Accordingly, these algorithms are amendable to meet the needs of a given situation.

FIG. 4C shows an exemplary illustrative flow for determining the travel time between two exits. Once an alternate route between two exits is found, as in step 319, the traffic for the alternate route can be retrieved 419. The traffic is then overlaid atop the alternate route 421, and a travel time with traffic is determined 423. This time can then be compared to the traffic-based travel time on the main route at step 323 to find an optimal route.

Although FIGS. 3-4C were presented as an illustrative process for avoiding traffic on a primary route, they could be used to avoid traffic on alternate routes, and they can even be performed iteratively within themselves, to find a dynamic, alternate route. They are also only one example of many methodologies for finding alternate routes.

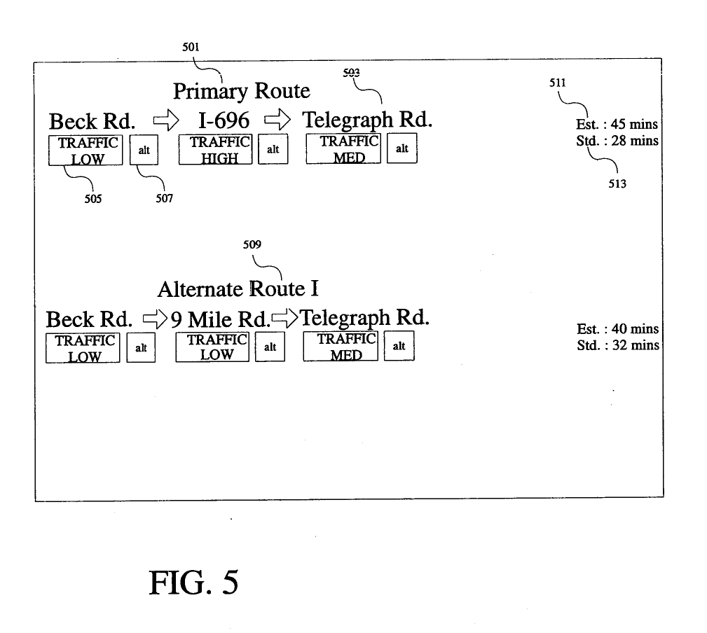

FIG. 5 shows one exemplary illustrative display of route summary and traffic information. This information could be displayed, for example, on a vehicle navigation system or other vehicle-based display. It could also be transmitted to a portable display that is removable from the vehicle, such as a portable navigation device, hand-held device, or other device having a suitable display. In addition or in lieu of a display, the relevant information could be relayed to the driver audibly, such as in the form of a dynamic route report and traffic report played through the car audio.

In FIG. 5, a primary route is presented to the driver 501 as a preferred route of travel when there is no traffic. In this illustrative embodiment, the route is one commonly traveled by the driver, so precise route details are not present. For example, it is a daily commute. Instead of dedicating screen space to specific driving details, in this summary form, the driver is just shown a rough breakdown of a route to be traveled, including main roads 503 on which travel will occur.

Another example of possible summary route determination and display procedures is shown in a co-pending application entitled “METHOD AND APPARATUS FOR PROVIDING A NAVIGATION SUMMARY”, U.S. application Ser. No. ______, the entire contents of which are incorporated herein by reference.

In addition to showing the route summary 503, the driver is also shown a traffic indicator 505 for each portion of the summarized route. Of course, if desired, a more complete route could be shown, and traffic for each relevant portion could be shown. Also, many alternatives to the exemplary traffic indicator are available.

The driver is also presented with a standard time indicator 513, showing how long a given route is estimated to take without traffic, and an estimated time indicator 511, showing how long a given route is estimated to take with the present traffic volume. Since the traffic can be updated in real time, these numbers can dynamically change as the driver is moving, giving a reasonably accurate estimated time-to-destination from any given point of travel.

Finally, in this illustrative implementation, at least one alternate route is also shown 509. This is a route that, given traffic conditions, is likely to be faster than the primary route, as is shown by the estimated travel time for the alternate route. Although this may not be the fastest route with traffic, traffic conditions may make this a more desirable route. More than one alternate route may be shown as well.

By showing an alternate route, the driver can make an educated decision about travel on either route. For example, if the driver knows that it is 8:05 am, and that traffic on the primary route typically clears between 8:15 and 8:45, because students have been dropped off and late-morning rush hour has not yet accumulated, the driver may wish to take the primary route.

In addition to the above described information, an “alternate” button 507 may also be displayed for use by the driver. This button, in this illustrative example, instructs the system to find a route-around, as described in conjunction with FIGS. 3-4C.

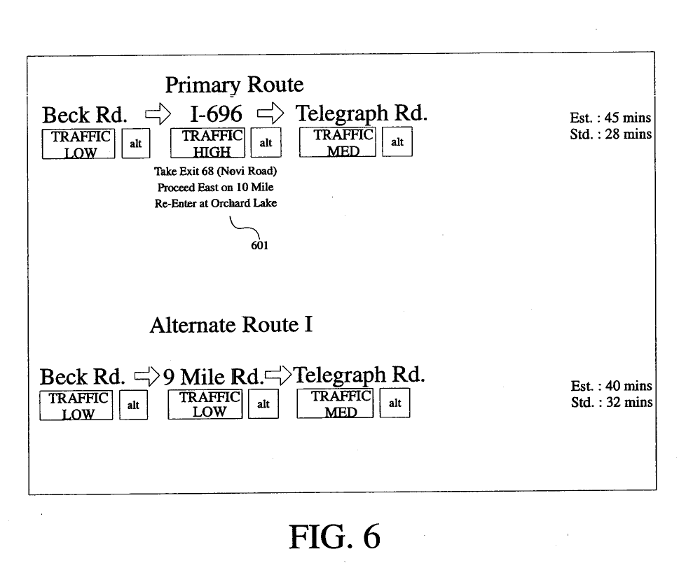

FIG. 6 shows the exemplary illustrative display of FIG. 5 with additional information displayed thereon. In this illustrative example, a route-around 601 that avoids the worst of the traffic on I-696 is shown, instructing the user to exit at exit 68, also called Novi Road, to proceed on 10 mile road until Orchard Lake Road is reached, and then to re-enter I-696 at that point (avoiding present traffic between Novi Road and Orchard Lake Road on I-696). In this manner, if a user wishes to remain on the main route generally, but to avoid traffic, the user can quickly request route-arounds for traffic present on portions of the main route, and will be shown the route-around (with traffic information if desired) for the high congestion areas of traffic.

In a further illustrative embodiment, a user may predefine a number of possible routes to a destination. For example, if there are three suitable and preferred ways for a user to travel from a home location to a work location, the user may preprogram all of those paths into a vehicle communication system. This could be done, for example, by loading these paths on a computer and loading (using, for example, a flash drive or a wireless communication connection, such as wifi) the routes into the vehicle based communication system.

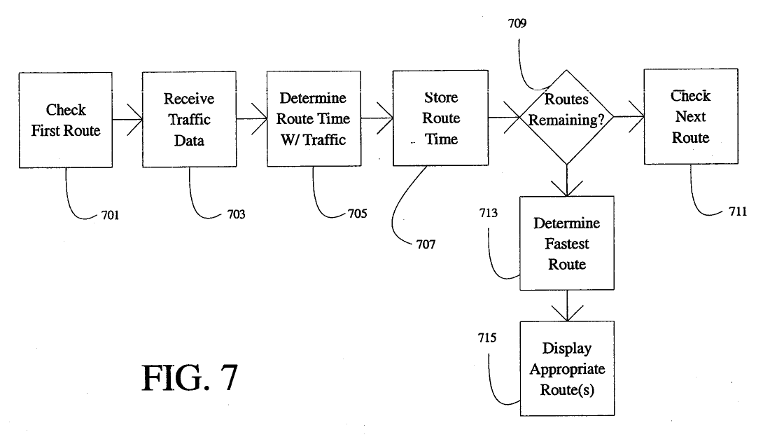

FIG. 7 shows an exemplary routine for determining and displaying preferred routes. First, the system will check a first route in a list of preferred routes 701. Once the system knows the roads in the preferred route 703, it receives traffic data for that route, based at least in part on the known roads. Using the traffic data, the system will determine a travel time for the first route based on the traffic 705. Finally, the system stores the route time in a memory circuit and associates the stored time with the first route 707.

Next, the system checks to see if there are any additional preferred routes remaining 709. If so, the system selects a next route for processing 711, and repeats the steps leading to a determination of route time with traffic.

If there are no routes remaining, the system determines, based at least in part on the stored route times, which route is the fastest route to take 713. The system displays this route, possibly with traffic information, and the system may also display additional routes, with estimated times and traffic information if desired.

Further, route selection could be user configurable. For example, a user may prefer a shorter (distance wise) route even though it takes longer, unless the time difference is significant. So, in this illustrative non-limiting example, the user could have a predetermined definition that a certain route is to be listed as the preferred route unless the travel time difference is greater than a certain amount. Other user defined variables could also be configured as suitable. These variables could be configured while in the vehicle, or preconfigured and loaded into the vehicle based computer system.

While the invention has been described in connection with what are presently considered to be the most practical and preferred embodiments, it is to be understood that the invention is not to be limited to the disclosed embodiments, but on the contrary, is intended to cover various modifications and equivalent arrangements included within the spirit and scope of the appended claims.

What is claimed:

1. A vehicle communication system comprising:
a computer processor in communication with persistent and non-persistent memory;
one or more output devices controllable by the processor;
wherein a plurality of routes between a starting location and a destination are stored in at least one of the persistent and non-persistent memory;
wherein the processor is operable to receive traffic data relating to each of the plurality of preferred routes;
wherein the processor is operable to calculate an estimated travel time for each of the plurality of the preferred routes, based at least in part on the received traffic data;
wherein the processor is operable to select, from the preferred routes and based at least in part on the estimated travel time, an optimal route of travel to be output to at least one output device.

2. The system of claim 1, including a local wireless transceiver in communication with the computer processor and configured to communicate wirelessly with at least one intermediary wireless device, wherein communication between the processor and a remote network is possible through a wireless connection over the transceiver between the processor and the intermediary wireless device, and wherein traffic data is relayable from the remote network to the processor over the wireless connection.

3. The system of claim 1, wherein the one or more output devices include a speaker.

4. The system of claim 3, wherein the processor is further operable to output traffic information, including a traffic report.

5. The system of claim 1, wherein the one or more outputs include a visual display.

6. The system of claim 5, wherein the processor is further operable to output traffic information, including a visual indicator of traffic flow.

7. The system of claim 1, wherein the determination of an optimal route is based at least in part on one or more user definable variables.

8. The system of claim 7, wherein one user variable is a time difference between a first preferred route and a second preferred route.

9. The system of claim 1, wherein the processor is operable to output a plurality of recommended routes, including at least one optimal route and one alternative route.

10. A vehicle communication system comprising:
a computer processor in communication with persistent and non-persistent memory;
one or more output devices controllable by the processor;
wherein the processor is operable to receive traffic data relating to a route to be traveled and calculate an estimated time of travel along the route based at least in part on the received traffic data;
wherein the processor is operable to evaluate a subset of a route to be traveled to determine one or more portions having concentrations of traffic above a predetermined threshold;
wherein the processor is further operable to determine, for each portion having a concentration of traffic above the predetermined threshold, at least one alternative route, if an alternative route exists;
wherein the processor is further operable to receive traffic data relating to each determined alternative route and calculate an estimated time of travel along each alternative route based at least in part on the received traffic data; and
wherein the processor is operable to output one or more alternative routes, including traffic information, to at least one of the output devices.

11. The system of claim 10, further including at least one input, and wherein the processor is operable to output one or more alternative routes in response to an input user request.

12. The system of claim 11, wherein the input is a microphone.

13. The system of claim 12, wherein the input is a touch sensitive display.

14. The system of claim 13, wherein the touch sensitive display is also an output.

15. A vehicle communication system comprising:
a computer processor in communication with persistent and non-persistent memory and one or more output devices, controllable by the processor;
wherein the processor is operable to receive traffic data and determine, based at least in part on the received data, an optimal route of travel between two locations, the optimal route of travel being selected from a plurality of stored, user-input preferred routes;
wherein the processor is operable to output the optimal route including traffic information.

16. The system of claim 15, wherein the processor is further operable to output at least one alternative route.

17. The system of claim 15, wherein the processor is further operable to output traffic data.

18. The system of claim 17, wherein the traffic data is output in audio form.

19. The system of claim 17, wherein the traffic data is output in visual form.
